(19) United States
(12) Patent Application Publication
(10) Pub. No.: US 2001/0019379 A1
(43) Pub. Date: Sep. 6, 2001

(54) Front light type liquid crystal display

(76) Inventors: Takayuki Ishihara, Kyoto (JP); Hideharu Osawa, Kyoto (JP); Masao Saito, Kyoto (JP)

Correspondence Address: Michael D. Bednarek, SHAW PITTMAN, 1650 Tysons Boulevard, McLean, VA, 22102-4859, US

(21) Appl. No.: 09/771,590

(22) Filed: Jan. 30, 2001

(30) Foreign Application Priority Data
Jan. 31, 2000 (JP) 2000-21521
Jan. 31, 2000 (JP) 2000-21522
Feb. 2, 2000 (JP) 2000-25306

(51) Int. Cl. G02F 1/1335

(52) U.S. Cl. 349/65

(57) ABSTRACT

A lighting device includes a light source for illuminating an LCD panel, and a light guide for guiding light emitted from the light source to the panel. The light guide is provided with a main body facing the panel and with a light inlet section adjacent to the light source. The light inlet section includes a first surface facing the light source and a second surface which intersects the first surface at an angle smaller than 90°. The second surface is formed with a plurality of light reflecting grooves arranged at irregular intervals.

### BACKGROUND OF THE INVENTION

1. Field of the Invention

The present invention relates to a liquid crystal display. In particular, it relates to a front light type liquid crystal display.

2. Description of the Related Art

Liquid crystal displays (LCDS) are used in various electronic appliances for showing information. Conventionally, the LCDs are classified into two different types, namely, backlight type and front light type.

FIG. 19 of the accompanying drawings shows a conventional front light type LCD Y. As illustrated, the LCD Y includes a LCD panel 90, a light guide 94, and a light source 95 held in facing relation to the light inlet surface 94a of the light guide 94. The LCD panel 90 includes a pair of transparent plates 90a and 90b, liquid crystal 91 sealed between the plates 90a-90b, a pair of polarizing plates 92a and 92b, and a reflector 93 attached to the rear polarizing plate 92b. The light guide 94, attached to the front surface of the front polarizing plate 92a, has a front surface formed with a plurality of identical protrusions 94b. The light source 95 may include an elongated illuminating device (such as a cold-cathode tube) or a point illuminating device (such as a light-emitting diode).

The conventional LCD Y has the following disadvantage. When use is made of a point lighting device for the light source 95, the light emitted from the light source 95 is not uniformly distributed in the light guide 94. Hence, the light emitted from the light guide 94 to the LCD panel 90 tends to become uneven in brightness, thereby illuminating particular places of the panel surface more brightly or more dimly than any other place. Disadvantageously, such unevenness of illumination may cause the displayed information to be partially or even entirely unrecognizable.

### SUMMARY OF THE INVENTION

The present invention has been proposed under the circumstances described above, and its object is to provide a liquid crystal display capable of displaying required information clearly with the use of a point light source.

According to first aspect of the present invention, there is provided a lighting device including: a light source for illuminating an object; and a light guide for guiding light emitted from the light source to said object. The light guide is provided with a main body facing the above-mentioned object and with a light inlet section adjacent to the light source. The light inlet section includes a first surface facing the light source and a second surface intersecting the first surface at a predetermined angle smaller than 90°.

Preferably, the above-mentioned second surface may be provided with light reflecting means. The light reflecting means may includes a plurality of recesses formed in the second surface. These recesses may be a plurality of grooves arranged at irregular intervals. These intervals may be smaller as the grooves are farther from the above-mentioned first surface. Alternatively, the light reflecting means may include a plurality of projections formed in the above-mentioned second surface or a plurality of reflecting layers formed on the second surface.

Preferably, the main body may include a rear surface facing the above-mentioned object and a front surface opposite to the rear surface, wherein the front surface may be formed with a plurality of projections. According to a preferred embodiment, these projections may be different in configuration from each other so that the above-mentioned object is uniformly illuminated by the light from the light source.

According to a preferred embodiment, each of the projections maybe defined by a first slope and a second slope which is steeper than the first slope. In this case, the second slopes of the respective projections may be steeper as the projections are farther from the light source.

Each of the above projections, from a different point of view, may be defined by a plurality of grooves each having a triangular cross section. Each groove has a predetermined depth measured with reference to a line parallel to the rear surface of the main body. Preferably, the depths of the respective grooves may be greater as the grooves are farther from the light source.

According to a preferred embodiment, each of the above projections may have a predetermined pitch, and the pitches of the respective projections may be smaller as the projections are farther from the light source.

According to a second aspect of the present invention, there is provided a liquid crystal display comprising: a supporting member; a liquid crystal display panel supported by the supporting member and having a front surface and a rear surface; a light source for illuminating the panel; and a light guide for guiding light emitted from the light source to the panel. The light source is mounted on the supporting member. The supporting member may be a control board for the LCD panel.

Preferably, the light guide may be provided with a main body facing the front surface of the panel and with a light inlet section adjacent to the light source, wherein the light inlet section is offset toward the rear surface of the panel beyond the front surface of the panel. In this case, the LCD panel may include a side surface extending between the front surface and the rear surface, and the light inlet section may be held in contact with this side surface of the panel.

According to a preferred embodiment, the light guide may include an intermediate section connecting the light inlet section to the main body. The intermediate section may extend obliquely with respect to the supporting member. In this case, the light inlet section may be provided with a first surface facing the light source and with a second surface intersecting the first surface at a predetermined angle smaller than 90°, wherein the second surface is perpendicular to the supporting member.

Other features and advantages of the present invention will become apparent from the detailed description given below with reference to the accompanying drawings.

### BRIEF DESCRIPTION OF THE DRAWINGS

In the accompanying drawings:

FIG. 1 is a perspective view showing a liquid crystal display (LCD) according to a first embodiment of the present invention;

FIG. 2 is a sectional view showing the inside of the LCD of FIG. 1;

FIG. 3 illustrates two glass plates upon each of which a plurality of electrodes are formed;

FIG. 4 is a perspective view showing an LCD according to a second embodiment of the present invention;

FIG. 5 is a perspective view showing an LCD according to a third embodiment of the present invention;

FIG. 6 is a sectional view showing the inside of the LCD of FIG. 5;

FIG. 7 is a perspective view showing an LCD according to a fourth embodiment of the present invention;

FIG. 8 is a sectional view showing the inside of the LCD of FIG. 7;

FIG. 9 is a perspective view showing an LCD according to a fifth embodiment of the present invention;

FIG. 10 is a sectional view showing an LCD according to a sixth embodiment of the present invention;

FIG. 11 is a plan view showing the light guide shown in FIG. 10;

FIGS. 12-15 show the principal parts of modified light guides;

FIG. 16 is a sectional view showing an LCD according to a seventh embodiment of the present invention;

FIGS. 17-18 are sectional views showing modified light guides used for the LCD of FIG. 16; and

FIG. 19 is a sectional view showing a conventional LCD.

### DETAILED DESCRIPTION OF THE PREFERRED EMBODIMENTS

The preferred embodiment of the present invention will be described below with reference to the accompanying drawings. Throughout the figures, the same reference numerals or characters may be used to refer to identical or similar elements.

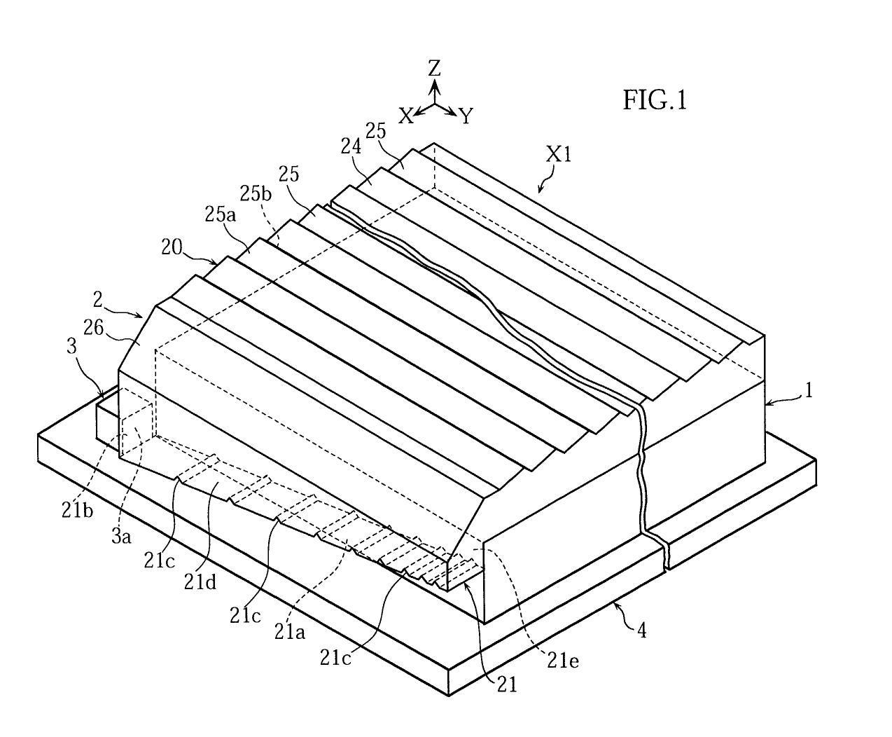

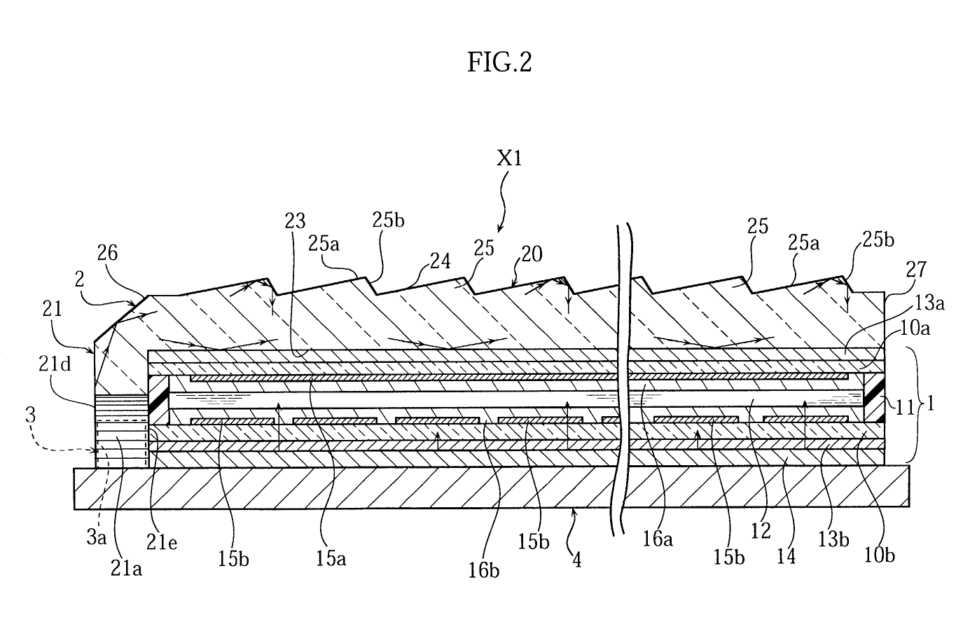

Reference is first made to FIGS. 1-3 illustrating a liquid crystal display (LCD) X1 according to a first embodiment of the present invention. As shown in FIGS. 1 and 2, the LCD X1 includes a liquid crystal display panel 1, a light guide 2, a point light source 3 and a wiring board 4. The upper (front) surface of the liquid crystal display panel 1 is entirely covered by the light guide 2, while the lower (rear) surface of the panel 1 is attached to the board 4. The light source 3 is mounted on the board 4.

As shown in FIG. 2, the LC panel 1 includes a first glass plate 10a, a second glass plate 10b, a sealing member 11, liquid crystal 12, a first polarizing plate 13a, a second polarizing plate 13b, and a reflector 14. The liquid crystal 12 is contained between the first and the second glass plates 10a, 10b by the sealing member 11. The first polarizing plate 13a is held in contact with the front surface of the first glass plate 10a, while the second polarizing plate 13b is held in contact with the rear surface of the second glass plate 10b. The reflector 14 is held in contact with the rear surface of the second polarizing plate 13b.

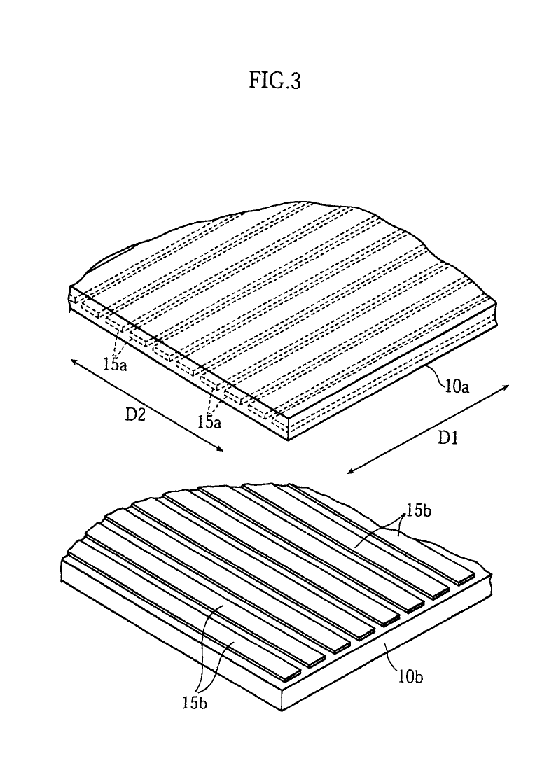

As shown in FIG. 3, the first glass plate 10a is provided, in its rear surface, with a plurality of first transparent electrodes 15a each of which extends in D1-direction. The transparent electrodes 15a are arranged at regular intervals in D2-direction perpendicular to the D1-direction. Similarly, the second glass plate 10b is provided, at its front surface, with a plurality of second transparent electrodes 15b each of which extends in the D2-direction. The second electrodes 15b are arranged at regular intervals in the D1-direction. Thus, the first and the second transparent electrodes 15a, 15b cross each other, thereby providing a plurality of pixels for displaying desired images (“passive matrix”). As shown in FIG. 2, the first electrodes 15a are covered by a first alignment layer 16a, while the second electrodes 15b are covered by a second alignment layer 16b.

The first and the second polarizing plates 13a, 13b allow the passage of light only when the light oscillates in a particular direction. For instance, the first polarizing plate 13a may allow the passage of light oscillating in a horizontal direction, while the second polarizing plate may allow the passage of light oscillating in a vertical direction.

The light guide 2, as shown in FIGS. 1 and 2, includes a main body 20 and a light inlet section 21, wherein the former entirely covers the front surface of the panel 1, while the latter partially covers a side surface of the panel 1. The main body 20 and the light inlet section 21 is formed integral with each other by molding a transparent resin material such as polycarbonate or polymethyl methacrylate (PMMA).

The main body 20 is provided with a flat, rear surface 23 and a non-flat front surface 24. The front surface 24 is formed with a plurality of undulations 25 each of which uniformly extends in a direction (in FIG. 1, Y-direction). Each undulation 25 is defined by two surfaces: a first slant surface 25a and a second slant surface 25b which is steeper than the first slant surface. Thus, as shown in FIG. 2, each undulation 25 has a generally triangular cross section.

The light inlet section 21, as stated above, partially covers a side surface of the panel 1, thereby projecting toward the board 4 beyond the rear surface 23 of the main body 20 (see FIGS. 1 and 2). The inlet section 21 is provided with a slant surface 21a facing the board 4, and with three side surfaces perpendicular to the board 4, namely, a first side surface 21b, a second side surface 21d and a third side surface 21e. The first side surface 21b is arranged in parallel to the third side surface 21e. As viewed vertically in FIG. 1, the length of the first side surface 21b is greater than that of the third side surface 21e. The second side surface 21d has a generally trapezoidal configuration.

The slant surface 21a of the inlet section 21 is formed with a plurality of grooves 21c for reflecting light. Each groove 21c extends perpendicularly to the longitudinal direction of the slant surface 21a. In the illustrated example, the groove 21c has a V-shaped cross section. The intervals between the grooves 21c are not constant, but become shorter as the grooves 21c are arranged closer to the third side surface 21e.

In the illustrated embodiment, the grooves 21c are formed only in the slant surface 21a. However, they may also be formed in the second side surface 21d or third side surface 21e. Further, instead of the grooves 21c, cone-shaped or spherical recesses or protrusions may be formed. Alternatively, the side surfaces 21a, 21d and 21e may be entirely covered by a single reflecting layer, or partially covered by a plurality of reflecting pieces. Such a reflecting layer or reflecting pieces may be provided by applying white paint to the above-mentioned side surfaces.

The light source 3 is provided with a light emitting surface 3a facing the first side surface 21b of the light inlet section 21. The light source 3 includes a light-emitting diode (LED) for example.

Though not illustrated in the figures, the wiring board 4 is provided with circuits necessary for driving the LCD panel 1 and the light source 3. The circuits may include drive ICs, a connector, etc.

According to the first embodiment described above, the LCD panel 1 and the light source 3 are mounted on the same wiring board 4. In this manner, advantageously, there is no need to prepare an additional wiring board used specifically for mounting the light source 3. Another advantage is that the circuit for the light source 3 and the circuit for the LCD panel 1 can be simultaneously formed on the board 4.

The function of the LCD X1 will now be described. In operation, the light source 3 emits light from the light emitting surface 3a. This light enters the light inlet section 21 of the light guide 2 via the first side surface 21b. Then, the light propagates through the inlet section 21, during which the light may be reflected on the surfaces 21a, 21d and 21e. When the light strikes upon the slant surface 21a, it may be reflected by the grooves 21c and directed in the forward direction of the LCD X1 (Z-direction in FIG. 1). Then, the forward light will reach the rectangular reflecting surface 26 arranged above the slant surface 21a. The reflecting surface 26 directs the forward light to the main body 20 of the light guide 2.

In the LCD X1, as shown in FIG. 1, the slant surface 21a of the light inlet section 21 is held in non-parallel relation to the normal direction of the light emitting surface 3a of the light source 3. In addition, the space or pitch between the light-reflecting grooves 21c formed in the surface 21a is made shorter as the grooves are positioned farther from the light source 3. Due to these features, the light from the light source 3 is reflected forward (Z-direction) less frequently by the grooves 21c at places closer to the light source than at places farther from the light source. However, the amount of light reaching the closer places is greater than the amount of light reaching the farther places. Thus, the amount of light reflected forward by the grooves 21c can be substantially equalized over the slant surface 21a. As a result, the light emitted from the light source 3 is uniformly led into the main body 20 from the light inlet section 21.

After entering the main body 20, the light will propagate through the main body 20 toward the side surface 27 (see FIG. 2) which is opposite to the reflecting surface 26. During the travel to the side surface 27, as shown in FIG. 2, the light may be totally reflected by the rear surface 23 or the front surface 24. However, when the light strikes on the rear surface 23 at an angle smaller than the critical angle, the light passes through the surface 23 and reaches the first polarizing plate 13a of the LCD panel 1. The polarizing plate 13a filters the light. Specifically, the polarizing plate 13a may allow the passage of only the horizontally oscillating light.

Thereafter, the direction of the oscillation of the light is changed by 90° by the twist in the liquid crystal 12, which may render the light to oscillate vertically. This light passes through the second polarizing plate 13b and is reflected on the reflector 14. Then, the light passes through the second polarizing plate 13b again, and is rotated through 90° by the liquid crystal 12, to become horizontally oscillating light. Then, the light passes through the first polarizing plate 13a and the main body 20, thereby going out from the LCD Xl in Z-direction shown in FIG. 1.

To display a desired image, voltage is applied to the selected pixels (intersections of the first electrodes 15a and the second electrodes 15b). When a voltage is applied to a pixel, the oscillating direction of the light passing the pixel does not change. As a result, the light filtered by the first polarizing plate 13a cannot pass through the second polarizing plate 13b, and the light filtered by the second polarizing plate 13b cannot pass through the first polarizing plate 13a. In either way, the light passing the voltage-applied pixel will not go out of the LCD 1, which causes the pixel to appear black.

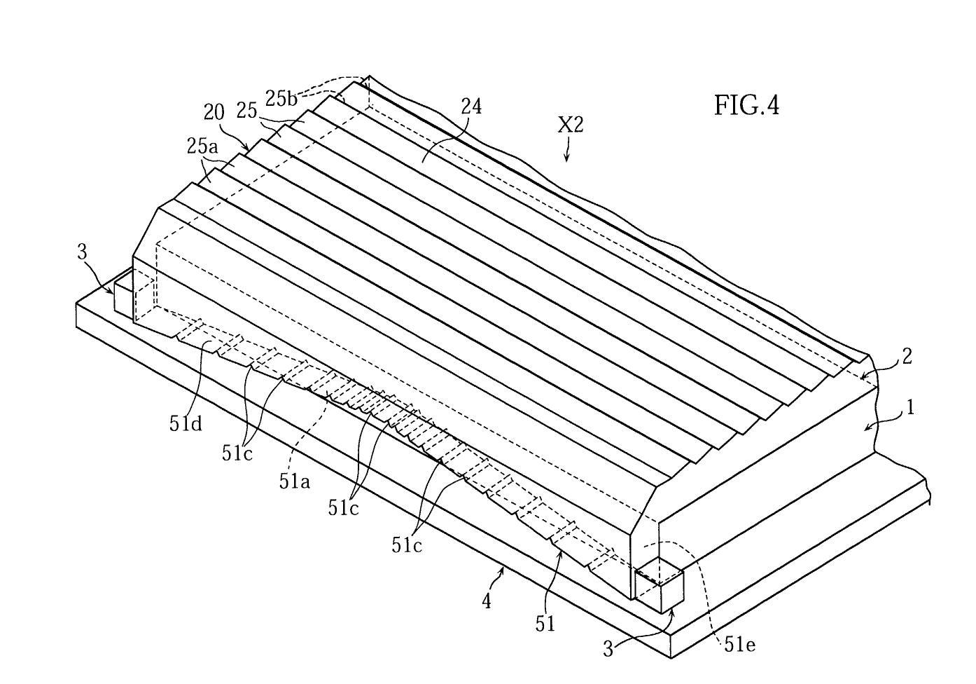

FIG. 4 shows an LCD X2 according to a second embodiment of the present invention. The LCD X2 is basically similar to the LCD X1 of the first embodiment except for the following differences.

Specifically, in the LCD X2, use is made of two light sources 3 located at the respective longitudinal ends of a light inlet section 51 of the light guide 2. Accordingly, the inlet section 51 has a configuration different from that of the inlet section 21 of the first embodiment. As shown in FIG. 4, the inlet section 51 has an elongated rear surface 51a whose central portion is spaced from the wiring board 4 to a greater extent than any other portion. As proceeding from the central portion toward the longitudinal ends, the rear surface 51a comes closer to the board 4, to finally touch the board 4 at the ends. This design divides the rear surface 51 into two symmetrical slopes each of which is formed with a plurality of light-reflecting grooves 51c. In each slope, the grooves 51c are arranged more densely as they are closer to the central portion of the rear surface 51a, so that uniform illumination is obtained over the rear surface 51a.

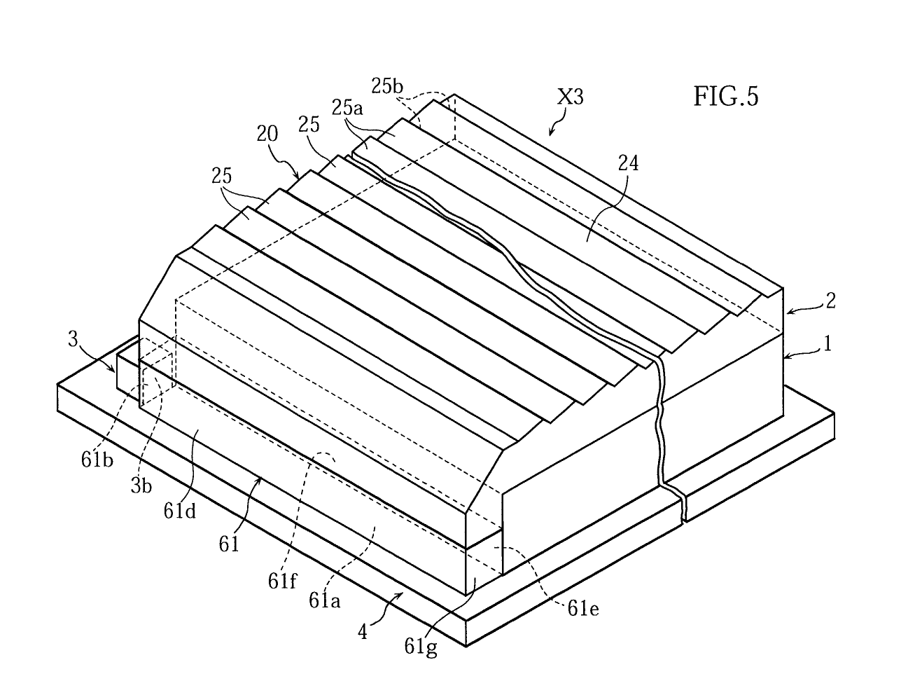

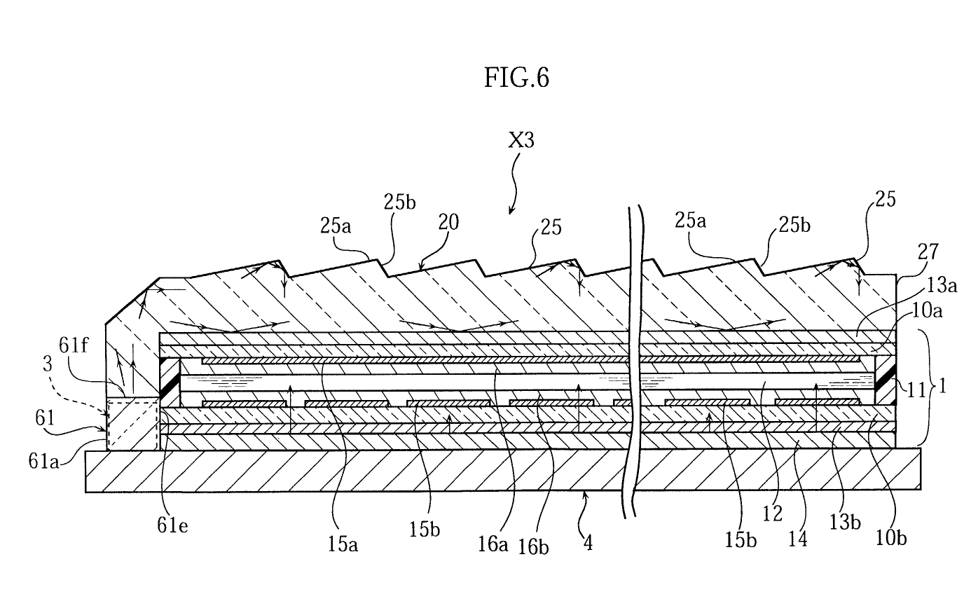

FIGS. 5 and 6 show an LCD X3 according to a third embodiment of the present invention. In the LCD X3, use is made of a light guide 2 consisting of separately prepared main body 20 and light inlet section 61. The main body 20 and the inlet section 61 may be made of the same transparent material (polycarbonate, PMMA, etc.) or different transparent materials. The inlet section 61, as shown in FIG. 5, has a uniformly elongated configuration having a rectangular cross section. The inlet section 61 includes four rectangular side surfaces 61a, 61d, 61e and 61f, and two rectangular end surfaces 61b and 61g. The end surface 61b is held in facing relation to the light emitting surface 3a of the light source 3. The light emitted from the light source 3 may be reflected on the above-mentioned side surfaces or end surface, and is eventually led into main body 20 from the inlet section 61 via the side surface 61f. To achieve efficient and uniform guiding of the light into the main body 20, the side surfaces 61a, 61d, 61e and the end surface 61g may be covered by a reflective layer. This layer may entirely or partially cover each of these surfaces. Instead of using such a reflective layer, light reflecting recesses or projections may be formed in the above surfaces.

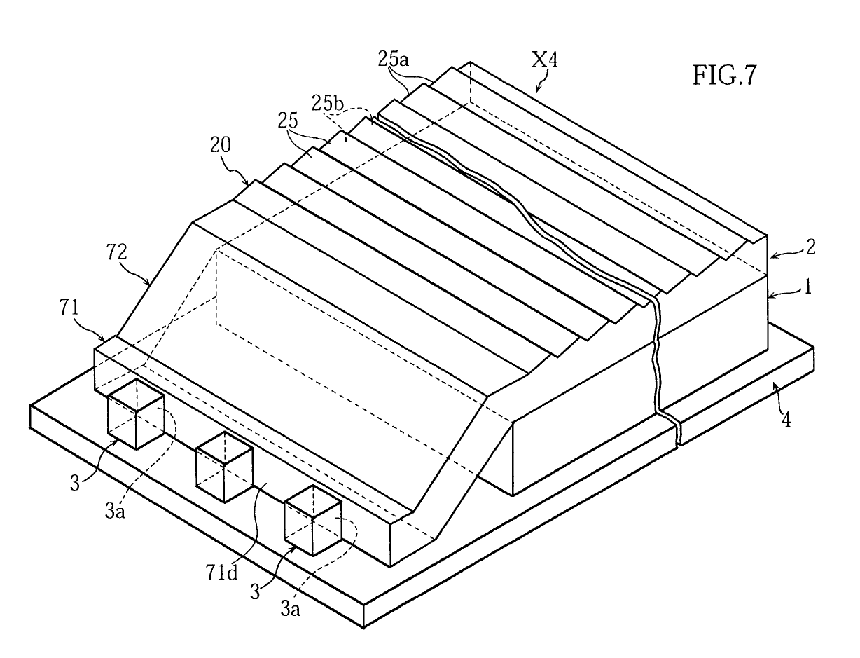

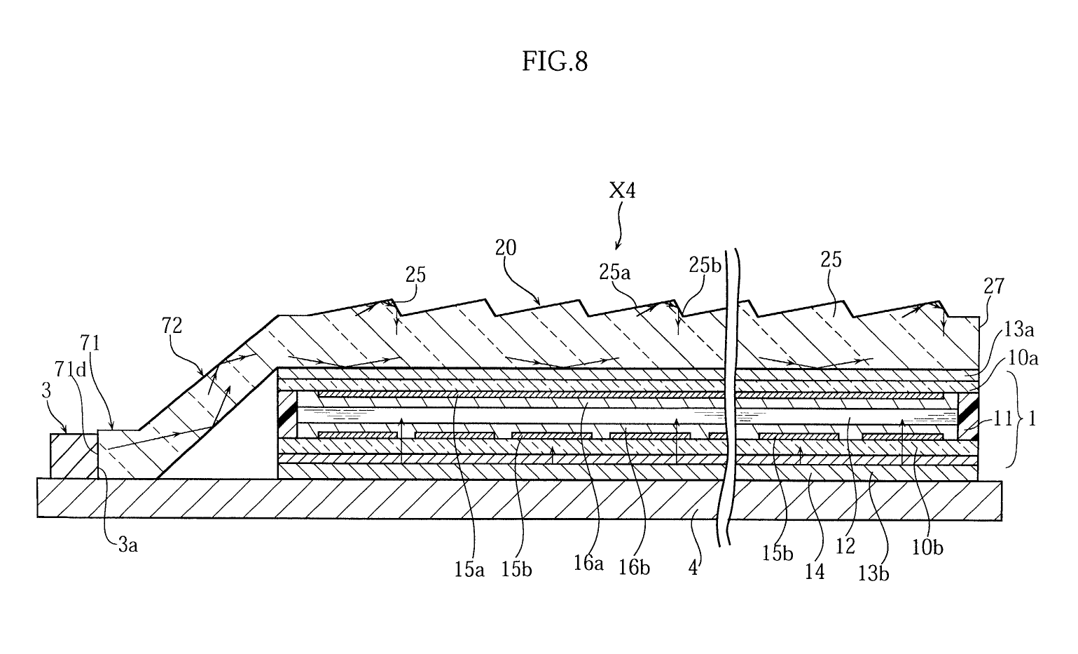

FIGS. 7 and 8 show an LCD X4 according to a fourth embodiment of the present invention. As illustrated, the light guide 2 includes a main body 20, a light inlet section 71 and a connecting section 72. The inlet section 71, arranged on the wiring board 4, is a uniformly elongated transparent bar having a rectangular cross section. The connecting section 72 extends obliquely with respect to the board 4 (see FIG. 8) to connect the light inlet section 71 to the main body 20 which is located ahead of (or above, in FIG. 8) the inlet section 71. The LCD X4 includes three light sources 3 whose light emitting surfaces 3a are held in facing relation to a side surface 71d of the inlet section 71. As shown in FIG. 8, the light emitted from the light sources 3 is led to the main body 20 from the inlet section 71 via the connecting section 72. The three light sources 3 may be replaced by a single elongated light source such as a cold cathode tube.

FIG. 9 shows an LCD X5 according to a fifth embodiment of the present invention. The light guide 2 of the LCD X5 is a hybrid of the light guide 2 of the LCD X1 (FIG. 1) and the light guide 2 of the LCD X4 (FIG. 7). Specifically, as seen from FIGS. 9 and 1, the light inlet section 81 of the LCD X5 is substantially the same as the light inlet section 21 of the LCD X1, though their postures relative to the wiring board 4 are different. As seen from FIGS. 9 and 7, the connecting section 82 and the main body 20 of the LCD X5 are similar to the counterparts of the LCD X4.

As shown in FIG. 9, the light inlet section 81 of the LCD X5 includes a slant surface 81a formed with a plurality of light-reflecting grooves 81b. The slant surface 81a is held in non-facing relation to the board 4. The inlet section 81 has a rectangular end surface to be held in contact with the light source 3.

In the above-described first to fifth embodiments, the light source 3 is mounted on the wiring board 4 together with the LCD panel 1 for achieving cost reduction and improving production efficiency. The present invention, however, is not limited to such a “one-board design.” As will be described below, the light source 3 may be detached from the board 4.

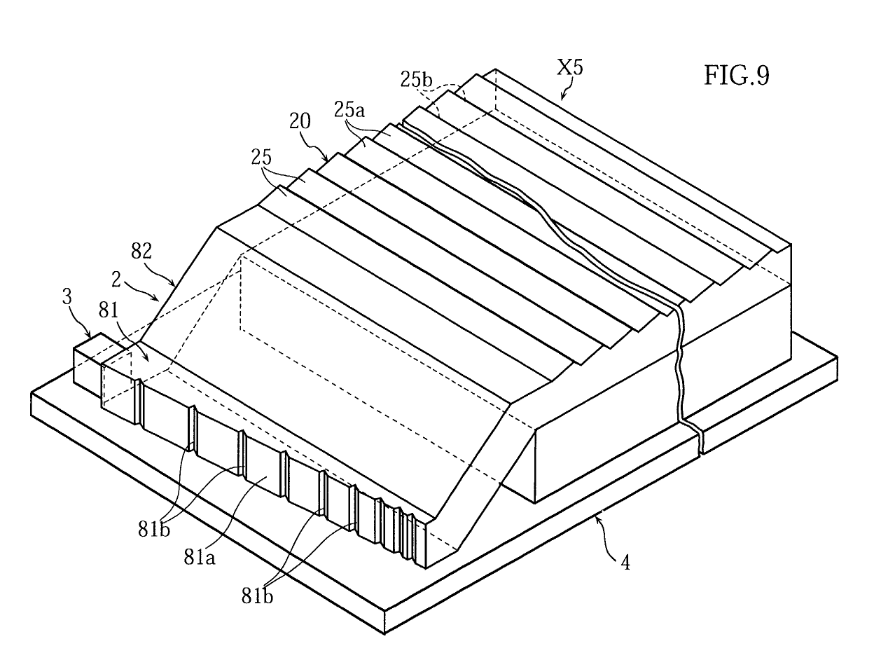

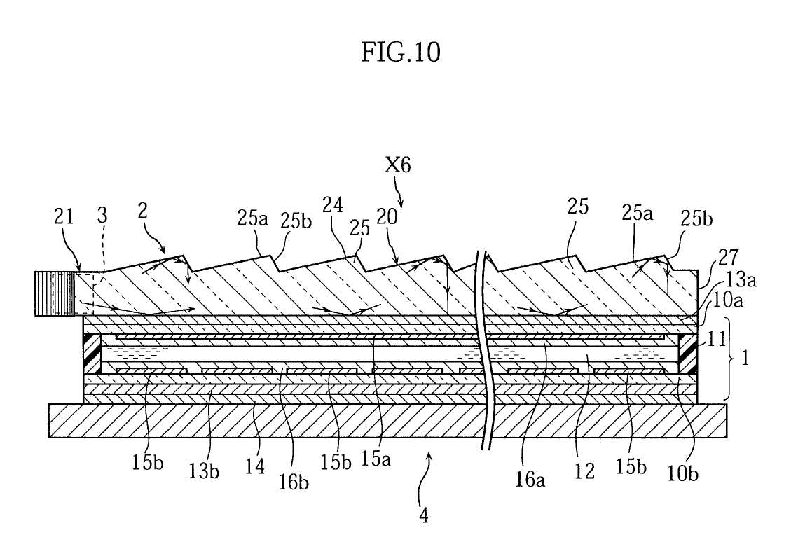

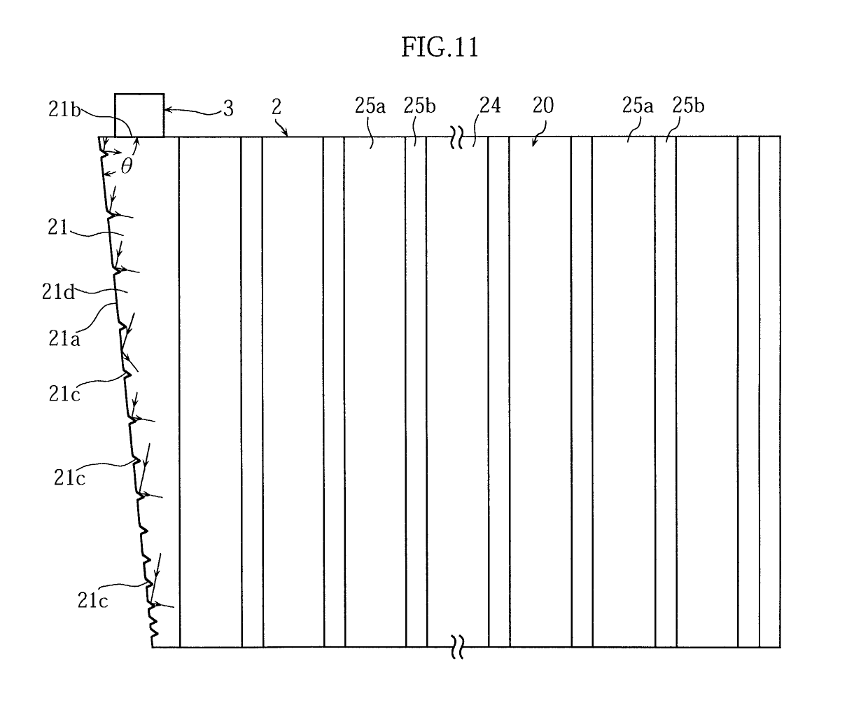

FIGS. 10 and 11 show an LCD X6 according to a sixth embodiment of the present invention. The LCD X6 includes an LCD panel 1, a light guide 2, a light source 3 and a wiring board 4. The LCD panel 1 is mounted on the board 4. The panel 1, as in the previously described LCDs, includes a first glass plate 10a, a second glass plate 10b, a sealing member 11, liquid crystal 12, a first polarizing plate 13a, a second polarizing plate 13b, and a reflector 14. The first glass plate 10a is provided, in its rear surface, with a plurality of first transparent electrodes 15a, while the second glass plate 10b is provided, at its front surface, with a plurality of second transparent electrodes 15b. The first electrodes 15a are covered by a first alignment layer 16a, while the second electrodes 15b are covered by a second alignment layer 16b.

The light guide 2 includes a main body 20 and a light inlet section 21 which is formed integral with the main body 20. The front surface 24 of the main body 20 is provided with a plurality of triangular projections 25 each of which is defined by a relatively gentle slope 25a and a relatively steep slope 25b. The light inlet section 21, as opposed to the counterparts of the LCD X1-X5, is completely spaced from the board 4. Accordingly, the light source 3, which is held in contact with the inlet section 21 (see FIG. 3), is detached from the board 4. Though not illustrated, the light source 3 is mounted on a wiring board which is prepared separately from the depicted board 4.

As shown in FIG. 11, the light inlet section 21 includes a slant surface 21a, an end surface 21b contacting the light-emitting surface 3a of the light source 3, and a trapezoidal front surface 21d. The inlet section 21 also includes a trapezoidal rear surface (not shown) which is opposite and identical to the front surface 21d. The slant surface 21a and the end surface 21b intersect at a predetermined angle θ smaller than 90°. The slant surface 21a is formed with a plurality of light-reflecting grooves 21c. In this embodiment again, the density of the grooves 21c is rendered greater as the distance from the light source 3 becomes greater.

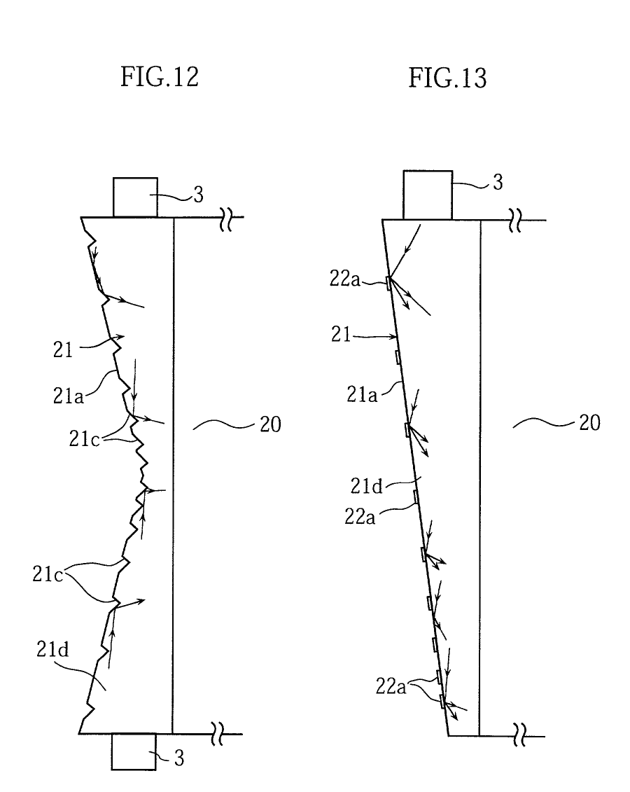

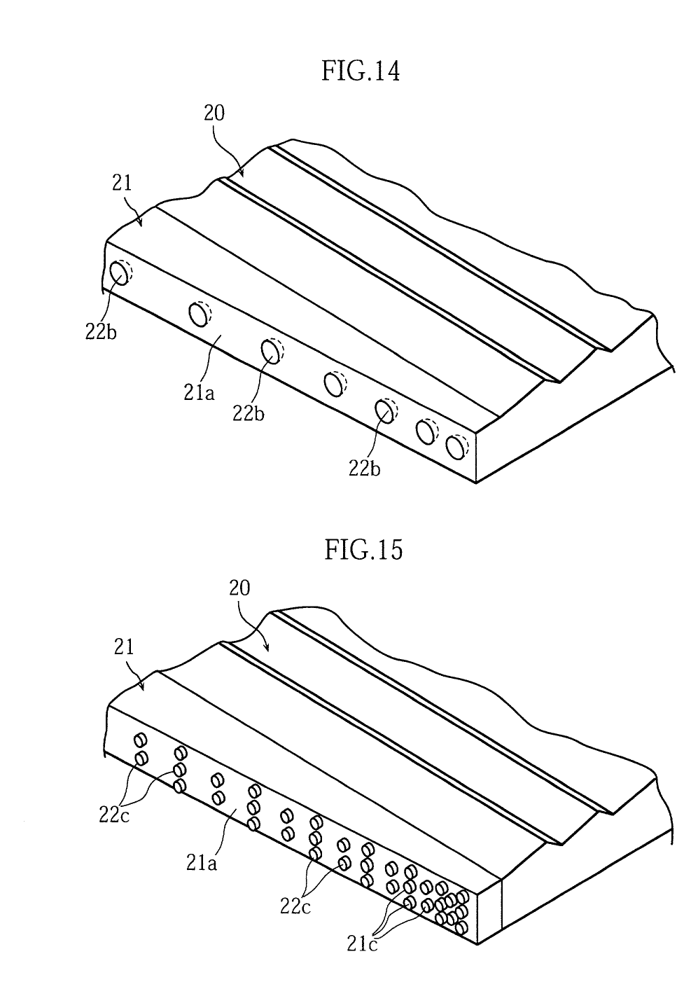

FIGS. 12-15 show examples of a modified light inlet section 21. The light inlet section 21 of FIG. 12 is substantially the same as the light inlet section 51 shown in FIG. 4. The light inlet section 21 of FIG. 13 includes a smooth slant surface 21a upon which a plurality of light-reflecting pieces 22a are provided in place of light-reflecting grooves as shown in FIG. 12. The light inlet section 21 of FIG. 14 is formed with a plurality of semi-spherical light reflecting recesses 22b in the slant surface 21a. The light inlet section 21 of FIG. 15 is formed with a plurality of light reflecting projections 22c in the slant surface 21a.

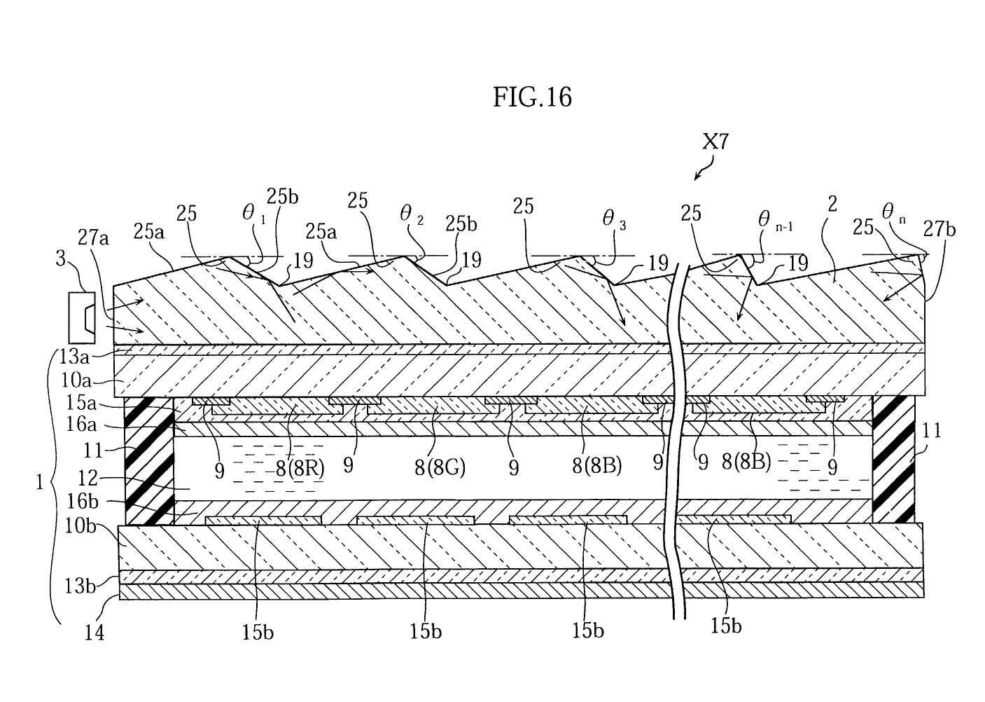

Reference is now made to FIG. 16 showing a color LCD X7 according to a seventh embodiment of the present invention. The LCD X7 includes an LCD panel 1, a light guide 2 and a light source 3. The light guide 2 is attached to the front surface of the panel 1. The light source 3 may be held in facing relation to the light inlet surface 27a of the light guide 3. The light source may be provided with a single or plurality of LEDs, or a single cold-cathode tube.

As shown in FIG. 16, the LCD panel 1 includes a first transparent plate 10a, a second transparent plate 10b, a sealing member 11, liquid crystal 12, a first polarizing plate 13a, a second polarizing plate 13b and a reflector 14. The first transparent plate 10a is provided with three kinds of color filters 8(8R, 8G, 8B) and a black matrix 9. Further, the first transparent plate 10a is provided with first transparent electrodes 15a and a first alignment layer 16a. Likewise, the second transparent plate 10b is provided with second transparent electrodes 15b and a second alignment layer 16b. The illustrated LCD panel 1 employs the active matrix, in which each liquid crystal cell is provided with a thin film transistor (TFT) for maintaining the voltage applied to the cell.

In the light guide 2 of the seventh embodiment again, the rear surface is flat, whereas the front surface is formed with a plurality of projections 25 each of which defined by a first and a second slopes 25a, 25b. The distance (or pitch) between the most retreated points 19 in the front surface of the light guide 2 is constant (about 300 μm or less).

In each of the first to the sixth embodiments described above, all the projections 25 of the light guide 2 are made identical. In the seventh embodiment, however, the respective projections 25 have different configurations so that light will be reflected differently by the projections 25, thereby being uniformly distributed over the front surface of the LCD panel 1. Specifically, as shown in FIG. 16, the depression angles θ1−θn associated with the respective projections 25 are determined such that θ1<θ2< . . . <θn, whereby the second slopes 25b of the respective projections 25 become steeper as they are located closer to the second side surface 27b than to the first side surface (light inlet surface) 27a.

In the above embodiment, the depression angles θ1−θn become greater gradually. The present invention, however, is not limited to this. For instance, the depression angles may be determined such that θ1=θ2<θ3=θ4<. . . <θn−1=θn.

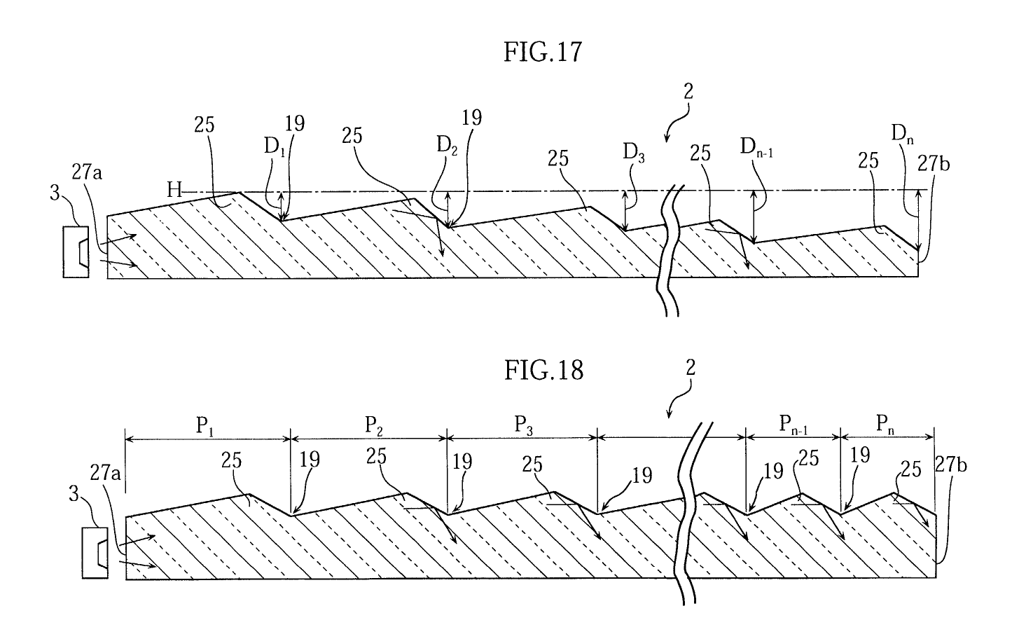

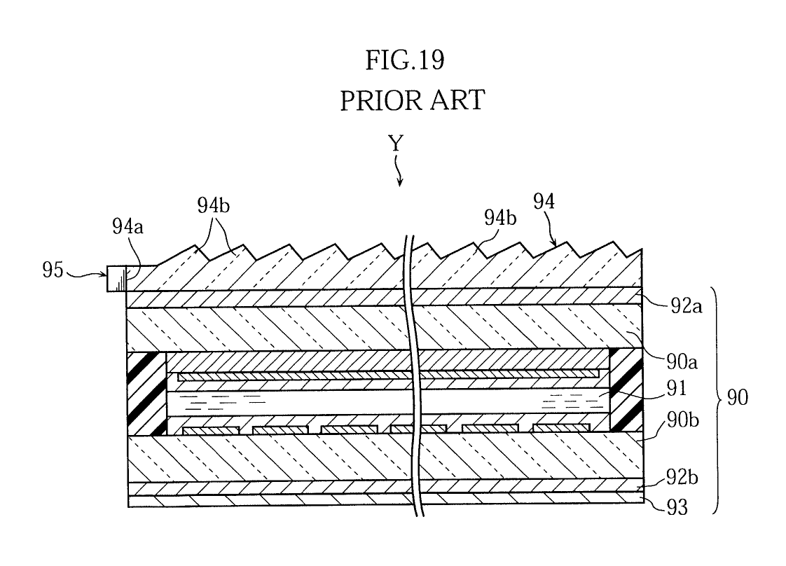

FIG. 17 shows an example of a modified light guide 2 used for the LCD X7. In the illustrated light guide 2, the depths D1-Dn of the valleys defined between the projections 25 are determined such that D1<D2<. . . <Dn−1<Dn (the single-dot chain line H is a reference line parallel to the rear surface of the light guide 2). With such an arrangement, the light emitted from the light source 3 can properly strike upon not only the slopes of the projections 25 near the light source 3, but also the slopes of the projections 25 which are relatively far from the light source 3. Consequently, the emitted light will be uniformly reflected toward the LCD panel 1 (see FIG. 16).

In the example shown in FIG. 17, the apexes of the projections 25 are spaced from the imaginary reference line H by different degrees except for the projection 25 closest to the light source 3. According to the present invention, however, all the apexes of the projections 25 may touch the reference line H, while the depths D1-Dn maintain the above-mentioned relation.

FIG. 18 shows another example of a modified light guide 2 used for the LCD X7. In the illustrated guide 2, the pitches between the most retreated points 19 on the front surface of the guide 2 are determined such that P1>P2>. . . >Pn, which causes the density of the projections 25 to increase as the projections 25 are located closer to the second side surface 27b than to the light inlet surface 27a of the guide 2. With the use of such a light guide 2, the light emitted from the light source 3 is properly led to the LCD panel 1, to uniformly illuminate the panel 1.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A lighting device comprising:
a light source for illuminating an object; and
a light guide for guiding light emitted from the light source to said object, the light guide being provided with a main body facing said object and with a light inlet section adjacent to the light source, the light inlet section including a first surface facing the light source and a second surface intersecting said first surface at a predetermined angle smaller than 90°.

2. The device according to claim 1, wherein said second surface is provided with light reflecting means.

3. The device according to claim 2, wherein the light reflecting means includes a plurality of recesses formed in said second surface.

4. The device according to claim 2, wherein the light reflecting means includes a plurality of grooves arranged at irregular intervals.

5. The device according to claim 4, wherein said intervals are smaller as the grooves are farther from said first surface.

6. The device according to claim 2, wherein the light reflecting means includes a plurality of projections formed in said second surface.

7. The device according to claim 2, wherein the light reflecting means includes a plurality of reflecting layers formed on said second surface.

8. The device according to claim 1, wherein the main body includes a rear surface facing said object and a front surface opposite to the rear surface, the front surface being formed with a plurality of projections.

9. The device according to claim 8, wherein the projections are different in configuration from each other so that said object is uniformly illuminated.

10. The device according to claim 9, wherein each of the projections is defined by a first slope and a second slope steeper than the first slope, the second slopes of the respective projections being steeper as the projections are farther from the light source.

11. The device according to claim 9, wherein the projections are defined by a plurality of grooves each of which has a triangular cross section and a predetermined depth measured with reference to a line parallel to the rear surface of the main body, the depths of the respective grooves being greater as the grooves are farther from the light source.

12. The device according to claim 9, wherein each of the projections has a predetermined pitch, the pitches of the respective projections being smaller as the projections are farther from the light source.

13. A liquid crystal display comprising:
a supporting member
a liquid crystal display panel supported by the supporting member and having a front surface and a rear surface;
a light source for illuminating the panel; and
a light guide for guiding light emitted from the light source to the panel;
wherein the light source is mounted on the supporting member.

14. The display according to claim 13, wherein the light guide is provided with a main body facing the front surface of the panel and with a light inlet section adjacent to the light source, the light inlet section being offset toward the rear surface of the panel beyond the front surface of the panel.

15. The display according to claim 14, wherein the panel includes a side surface extending between the front surface and the rear surface, the light inlet section being held in contact with said side surface.

16. The display according to claim 14, wherein the light inlet section includes a first surface facing the light source and a second surface intersecting the first surface at a predetermined angle smaller than 90 °.

17. The display according to claim 16, wherein the second surface is formed with a plurality of grooves arranged at irregular intervals.

18. The display according to claim 17, wherein the second surface faces the supporting member.

19. The display according to claim 14, wherein the light guide comprises an intermediate section connecting the light inlet section to the main body, the intermediate section extending obliquely with respect to the supporting member.

20. The display according to claim 19, wherein the light inlet section is provided with a first surface facing the light source an d with a second surface intersecting the first surface at a predetermined angle smaller than 90°, the second surface being perpendicular to the supporting member.
